(19) United States
(12) Patent Application Publication
(10) Pub. No.: US 2014/0174272 A1
(43) Pub. Date: Jun. 26, 2014

(54) Power Saw with Blade Guard Retraction Device

(71) Applicants: ROBERT BOSCH TOOL CORPORATION, Broadview, IL (US); ROBERT BOSCH GMBH, Stuttgart (DE)

(72) Inventor: Patrick Eiswerth, Chicago, IL (US)

(73) Assignees: Robert Bosch GmbH, Stuttgart (DE); Robert Bosch Tool Corporation, Broadview, IL (US)

(21) Appl. No.: 13/726,014

(22) Filed: Dec. 22, 2012

(51) Int. Cl. B23D 47/00

(52) U.S. Cl. CPC B23D 47/00
USPC 83/397

(57) ABSTRACT

A power saw includes a base portion, a support assembly, a cutting arm, a blade guard, a linkage arm, and a biasing member. The support assembly is supported by the base portion. The cutting arm is supported by the support assembly and is configured to rotatably support a saw blade. The cutting arm is movable between a lower position adjacent to the base portion and an upper position spaced apart from the base portion. The blade guard is rotatably supported by the cutting arm and is configured to receive a portion of the saw blade therein. The linkage arm includes a first end portion pivotally connected to the blade guard, and a second end portion movably supported by the support assembly. The biasing member is operably connected to the second end portion and is configured to bias the linkage arm.

### FIELD

This patent relates generally to power saws and particularly to a device for retracting the lower blade guard of a power saw.

### BACKGROUND

Power saws are used for sawing material, for example, construction lumber. One type of power saw, commonly referred to as a miter saw or a compound miter saw, typically includes a base configured for placement on a stand, a table, or on the ground. A turntable is rotatably supported by the base. The turntable defines a workpiece support surface, which is used to support a workpiece to be cut by the miter saw. A support assembly of the miter saw extends from the turntable, and a cutting arm is movably connected to the support assembly. The cutting arm includes an electric motor configured to rotate a circular saw blade. The cutting arm is positionable relative to the workpiece support surface to make square cuts and bevel cuts in the workpiece.

A workpiece is cut with the miter saw by moving the cutting arm downward relative to the base, such that the rotating saw blade is moved through the workpiece. After completing the cut, the cutting arm is moved upwards to extract the saw blade from the kerf formed in the workpiece.

On at least some miter saws, the cutting arm defines a blade guard space that covers an upper portion of the saw blade. Additionally, the cutting arm includes a movable blade guard, sometimes referred to as a lower blade guard, which is rotatably connected to the cutting arm and is configured to rotate about a hub. A biasing member, typically a torsion spring located at the hub, biases the blade guard toward a closed position in which the blade guard covers most of a lower portion of the saw blade. When cutting a workpiece, the blade guard moves relative to the cutting arm toward an open position, against the force of the biasing member, to enable the saw blade to extend into the workpiece.

The blade guard of some miter saws interferes with removal of the saw blade from the cutting arm. This is because in order to remove the saw blade, the user must hold the blade guard in the open position, against the force of the biasing member while, at the same time, the user must loosen a fastening member from the cutting arm to release the saw blade. This process can be inconvenient and time consuming for some users.

The biasing member of the blade guard, and any linkage structure associated therewith, may also limit the maximum bevel angle to which the cutting arm is adjustable. This limitation often limits the bevel angle on the side of the saw blade on which the biasing member and linkage are positioned. For example, a miter saw having a torsion spring style biasing member and linkage system positioned on a right side of the saw blade may have a limited right bevel angle.

The position of the biasing member associated with the blade guard also results in the biasing member becoming damaged from dust and debris generated by the saw blade as a workpiece is cut. This is because the biasing member is typically positioned within the blade guard space near the hub of the blade guard. In this position, the biasing member contacts the dust and debris generated by the saw blade. When the biasing member is provided as spring, the dust and debris eventually clogs the spring coils and prevents the biasing member from functioning properly. Furthermore, when the biasing member is positioned near the hub of the blade guard, typically the vertical cutting capacity of the saw is reduced.

Therefore it is desirable for a miter saw to include a blade guard that effectively covers the saw blade. It is also desirable for a miter saw to have a blade guard that is retainable in the open position so that a user is able to quickly and conveniently change the saw blade. Additionally, it is desirable for a miter saw to have a blade guard that does not limit the bevel angle adjustment of the cutting arm. Furthermore, it is desirable for a miter saw to have a biasing member for the blade guard that is spaced apart from the dust and debris generated by the saw blade as it cuts a workpiece. Also, it is desirable for a miter saw to have a biasing member for the blade guard that does not reduce the vertical cutting capacity of the saw.

### SUMMARY

According to at least one embodiment of the disclosure, a power saw includes a base portion, a support assembly, a cutting arm, a blade guard, a linkage arm, and a biasing member. The support assembly is supported by the base portion. The cutting arm is supported by the support assembly and is configured to rotatably support a saw blade. The cutting arm is movable between a lower position adjacent to the base portion and an upper position spaced apart from the base portion. The blade guard is rotatably supported by the cutting arm and is configured to receive a portion of the saw blade therein. The linkage arm includes a first end portion pivotally connected to the blade guard, and a second end portion movably supported by the support assembly. The biasing member is operably connected to the second end portion and is configured to bias the linkage arm such that as the cutting arm moves from the lower position to the upper position, the linkage arm is biased by the biasing member and the linkage arm biases the blade guard toward a closed position.

### BRIEF DESCRIPTION OF THE DRAWINGS

The above-described features and advantages, as well as others, should become more readily apparent to those of ordinary skill in the art by reference to the following detailed description and the accompanying figures in which:

FIG. 1 is a perspective view of a power saw, as described herein, having a cutting arm shown in a lowered position and a blade guard shown in an open position;

FIG. 2 is a side elevational view of the power saw of FIG. 1, showing the cutting arm in an upper position and the blade guard in a closed position;

FIG. 3 is a perspective view of a portion of the power saw of FIG. 1, showing the cutting arm in the upper position and the blade guard in a partially open position;

FIG. 4 is a perspective view of the blade guard and a retraction assembly of the power saw of FIG. 1;

FIG. 5A is an exploded perspective view of the blade guard and the retraction assembly of the power saw of FIG. 1;

FIG. 5B is a right side perspective view of a seat portion of the retraction assembly of the power saw of FIG. 1;

FIG. 5C is a left side perspective view of the seat portion of FIG. 5B;

FIG. 6 is a side cross sectional view of the cutting arm and a side elevational view of the blade guard of the power saw of FIG. 1, showing the cutting arm in the upper position and the blade guard in the closed position; and

FIG. 7 is a side cross sectional view of the cutting arm and a side elevational view of the blade guard of the power saw of FIG. 1, showing the cutting arm in the upper position and the blade guard held in a blade change position.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the disclosure includes any alterations and modifications to the illustrated embodiments and includes further applications of the principles of the disclosure as would normally occur to one skilled in the art to which this disclosure pertains.

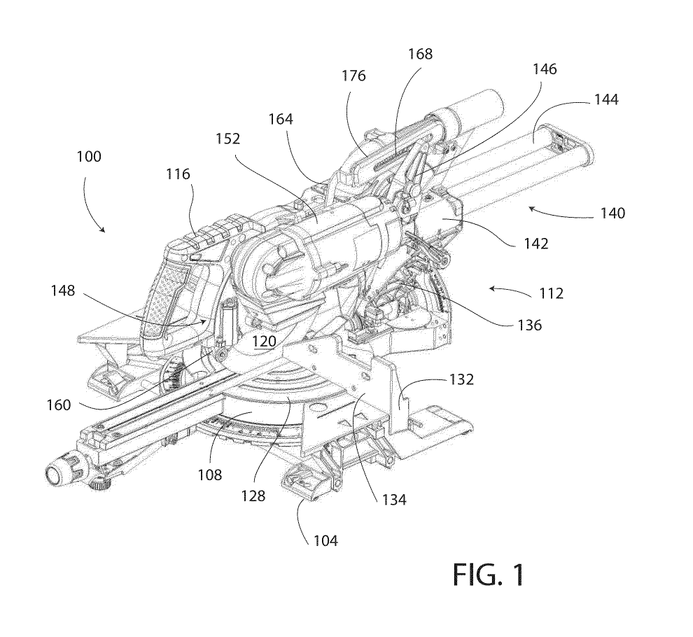

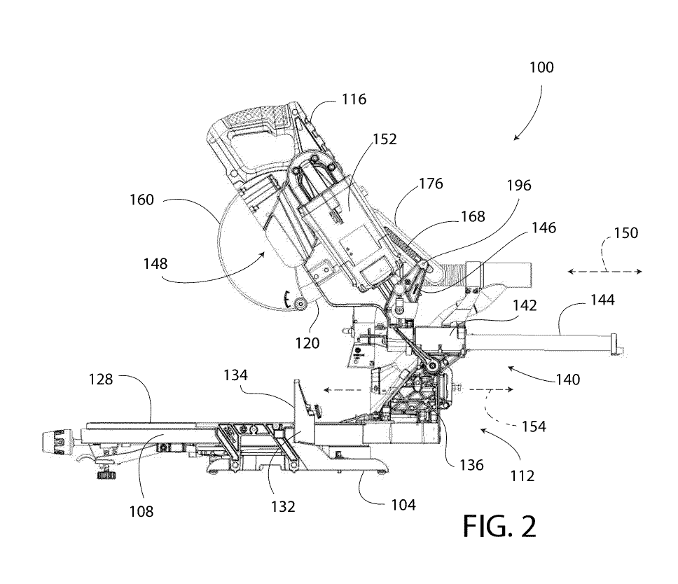

With reference to FIGS. 1 and 2, a power saw 100, shown as a sliding compound miter saw, includes a base portion 104, a turntable 108, a support assembly 112, a cutting arm 116, and a saw blade 120. The base portion 104 is configured for placement on a work surface (not shown). In one embodiment, the base portion 104 is at least partially formed from a rigid material such as aluminum, steel, plastic, and/or other suitable materials as desired by those of ordinary skill in the art.

The base portion 104 includes a fence member 132 configured to fixedly extend therefrom. The fence member 132 defines a face 134 against which a user may position a workpiece to be cut by the saw blade 120.

The turntable 108 is rotatably supported by the base portion 104, and is configured for movement relative to the base portion. The turntable 108 defines a workpiece support surface 128, which is a substantially flat surface on which a user may position a workpiece to be cut by the saw blade 120.

The support assembly 112 is supported by the base portion 104 and extends from the turntable 108. The support assembly 112 includes a support arm 136 and a slide assembly 140 that is pivotally and slidably moveable with respect to the support arm. The support arm 136 is configured to fixedly extend from a rear side of the turntable 108.

With continued reference to FIGS. 1 and 2, the slide assembly 140 includes a pivot structure 142, a rail assembly 144, and a yoke 146. The pivot structure 142 is pivotally connected to the support arm 136 and is configured for movement about a pivot axis 154 (FIG.

2) between a position of maximum left bevel and a position of maximum right bevel. The rail assembly 144 is slidably connected to the pivot structure 142 and is movable in the direction of the arrow 150 (FIG. 2) to enable to the power saw 100 cut though a workpiece that is wider than a diameter of the saw blade 120. The yoke 146 of the slide assembly 140 fixedly extends from an end portion of the rail assembly 144.

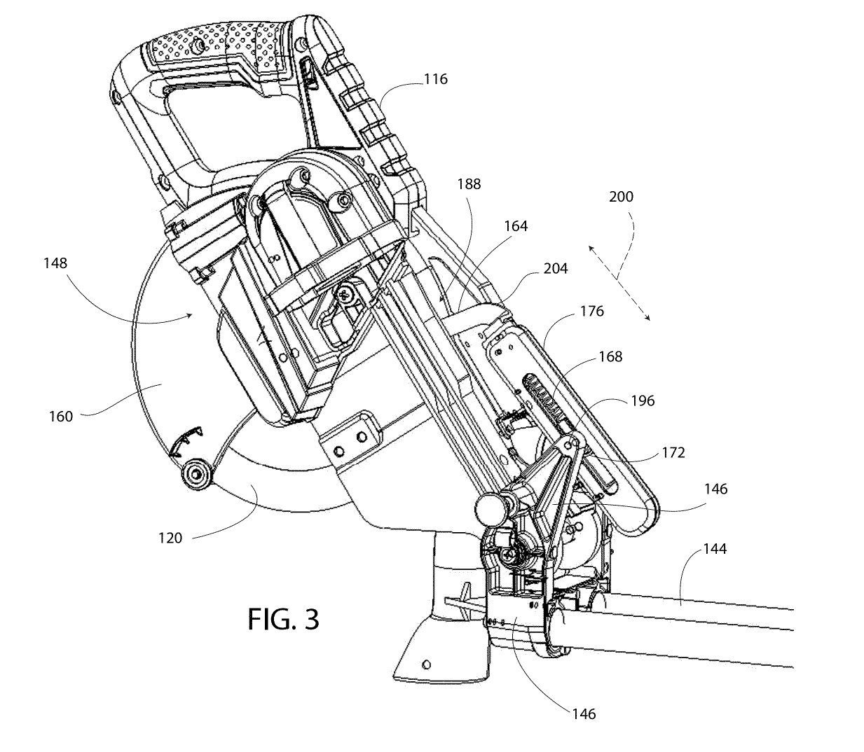

The cutting arm 116 is supported by the support assembly 112. In particular, as shown in FIG. 3, the cutting arm 116 is pivotally connected to the yoke 146 for movement between an upward position and a lowered position. In FIG. 1, the cutting arm 116 is shown in the lowered position adjacent to the base portion 104, and in FIGS. 2 and 3 the cutting arm is shown in the upper position that is spaced apart from the base portion.

The cutting arm 116 defines a blade guard space 148 in which a portion of the saw blade 120 is positioned. The cutting arm 116 rotatably supports the saw blade 120, which is rotated by an electric motor 152 (see FIG. 1, not shown in FIG. 3) of the cutting arm.

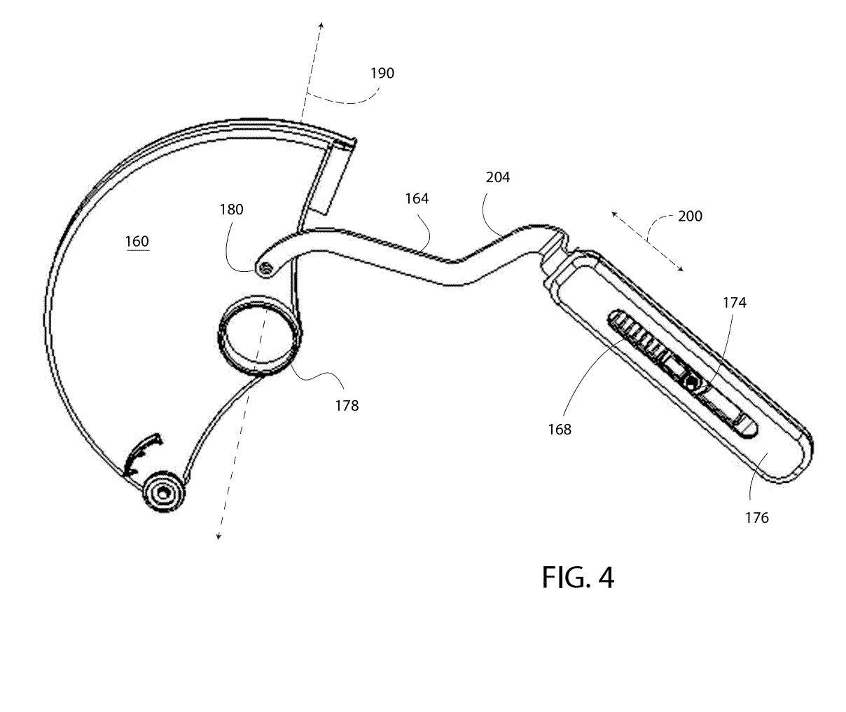

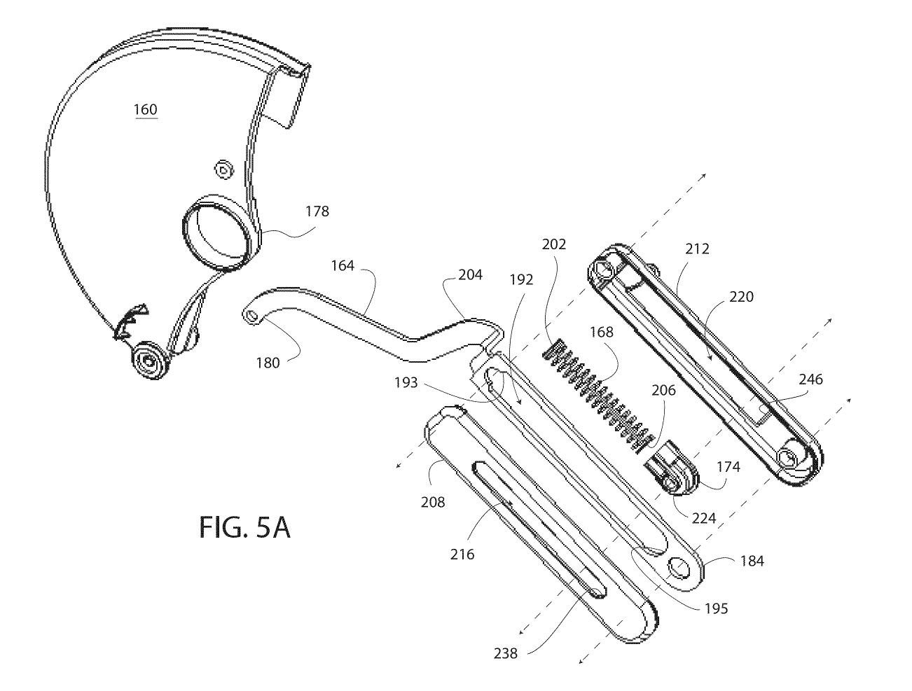

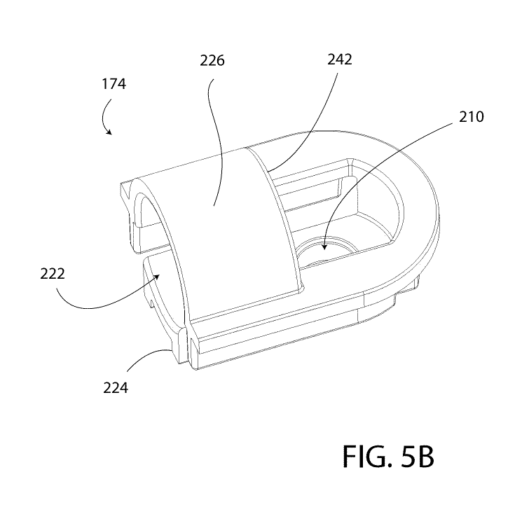

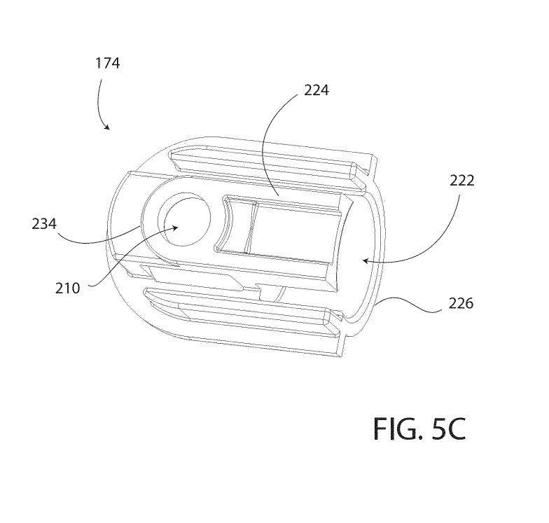

As shown in FIGS. 4 and 5, the power saw 100 also includes a blade guard 160, a linkage arm 164, a biasing member 168, a seat 174, and a housing assembly 176. The blade guard 160 is rotatably supported by the cutting arm 116, and a portion of the blade guard is positioned in the blade guard space 148. The blade guard 160 is configured for movement between an open position and a closed position about a hub 178 of the blade guard. The blade guard 160 is shown in an open position in FIG. 1, a partially open position in FIG. 3, and is shown in the closed position in FIG. 2. In at least one embodiment, the blade guard 160 is formed from injection molded thermoplastic. In other embodiments, the blade guard 160 is formed from any suitable material as desired by those of ordinary skill in the art.

The blade guard 160 is configured to receive a portion of the saw blade 120 therein. When the blade guard 160 is in the closed position, it receives at least the portion of the saw blade 120 that extends from the blade guard space 148 and, as a result, most or all of the saw blade is covered by either the cutting arm 116 or the blade guard.

With reference to FIG. 5A, the linkage arm 164 includes a first end portion 180, a second end portion 184, and a middle portion 204. The first end portion 180 is pivotally connected to the blade guard 160 and is positioned in the blade guard space 148 through a passage 188 (FIG. 3) in the cutting arm 116. The blade guard 160 rotates easily and smoothly between the open and closed positions about the hub 178, since the connection point of the first end portion 180 to the blade guard 160 is near an axis of rotation 190 (FIG. 4) of the blade guard.

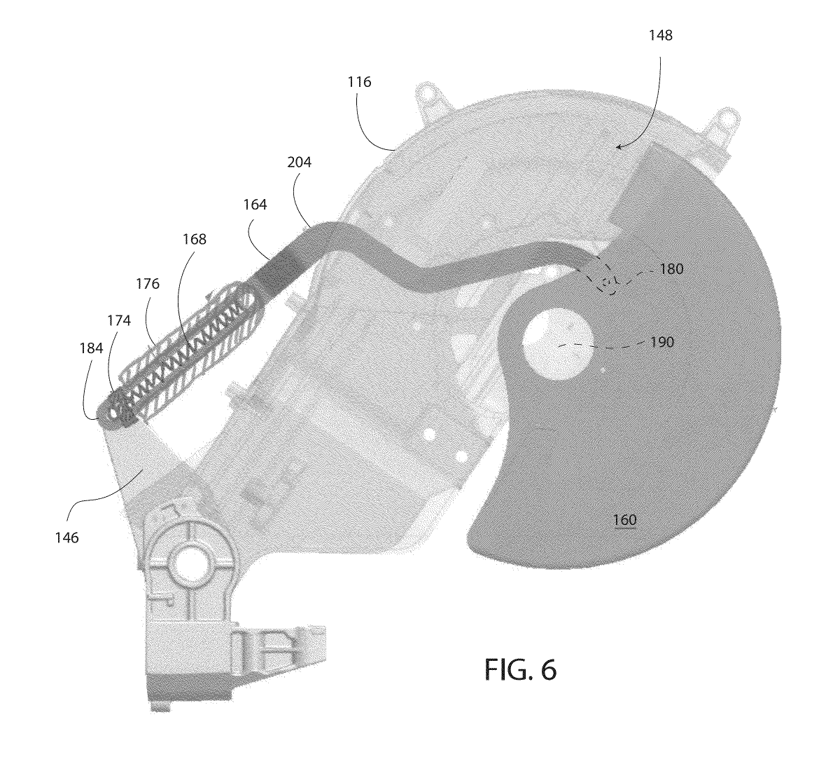

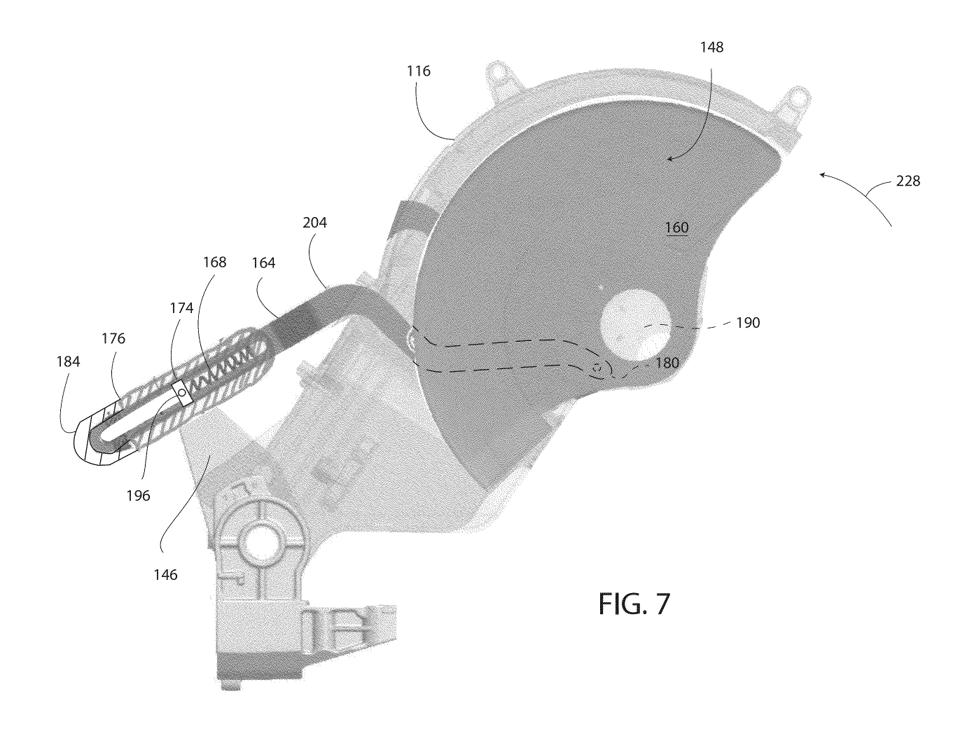

The second end portion 184 defines a slot 192 having first slot end portion 193 and a second slot end portion 195. A pin 196 (FIG. 2) extends through the slot 192 and the yoke 146, such that the second end portion 184 is movably supported by the yoke 146. The pin 196 is fixedly supported by the yoke 146, and the linkage arm 164 is pivotable and slidable about the pin 196. The linkage arm 164 is shown in a first sliding position in FIG. 6 and in a second sliding position in FIG. 7. The second end portion 184 extends along an axis 200 (FIG. 4).

The linkage arm 164 further includes a middle portion 204 that is located between the first end portion 180 and the second end portion 184. The middle portion 204 is angled with respect to the axis 200. The angle defined by the middle portion 204 and the axis 200 is between approximately 65 and 90 degrees. In one embodiment, the angle is approximately 85 degrees.

The biasing member 168 is positioned in the slot 192 of the linkage arm 164. The biasing member 168 is operably connected to the second end portion 184 of the linkage arm 164. Specifically, a first end portion 202 of the biasing member 168 is positioned against the first slot end portion 193. A second end portion 206 of the biasing member 168 is positioned against the seat 174, which as described below, is connected to the pin 196. Accordingly, the biasing member 168 is operably connected to the pin 196. The biasing member 168 is shown as a compression spring that generates a biasing force along the axis 200.

The seat 174 is at least partially positioned within the slot 192. The seat 174 defines an opening 210 (shown in FIGS. 5B and 5C) through which the pin 196 extends to operably connect the seat to the pin. The seat 174 receives at least a portion of the biasing member 168, such that the seat is also operably connected to the biasing member. The seat 174 is pivotal about the pin 196, and is movable relative to the linkage arm 164 along the slot 192.

With reference again to FIG. 4, the housing assembly 176 is coupled at least to a portion of the second end portion 184 of the linkage arm 164. At least a portion of the biasing member 168 is positioned in the housing assembly 176 to prevent damage to the biasing member from dust and debris, and to provide mounting features, as described below. In another embodiment, the power saw 100 does not include the housing assembly 176, and the biasing member 168 is protected from dust and debris since the biasing member is spaced apart from the blade guard space 148 and the blade guard 160.

As shown in FIG. 5A, the housing assembly 176 includes a left housing assembly member 208 connected to a right housing assembly member 212. The left housing assembly member 208 defines a left slot passage 216 therethrough, and the right housing assembly member 212 defines a right slot passage therethrough 220. The left slot passage 216 and the right slot passage 220 are at least partially aligned with the slot 192 defined by the linkage arm 164.

As shown in FIGS. 5B and 5C, the seat 174 further defines a biasing member opening 222 and includes a left guide 224 and a right guide 226. The biasing member opening 222 is configured to receive the second end portion 206 of the biasing member 168 therein. The left guide 224 and the right guide 226 are slidably positioned in the left slot passage 216 and the right slot passage 220 respectively. As shown in FIG. 5B, the right guide 226 defines a generally flat stop surface 242, which is positionable against a correspondingly shaped stop portion 246 of the right housing assembly member 212 (depending on the position of the linkage arm 164). As shown in FIG. 5C, the left guide 224 defines a curved stop surface 234, which is positionable against a correspondingly shaped stop portion 238 of the left housing assembly member 208 (depending on the position of the linkage arm 164). As the linkage arm 164 slides about the pin 196 between the first sliding position and the second sliding position, the left guide 224 and the right guide 226 prevent any significant rotation of the linkage arm 164 about the axis 200.

In operation, the miter saw 100 is configured to cut a workpiece. To cut a workpiece, first the user positions the workpiece on the workpiece support surface 128, typically against the face 134 of the fence 132. Next, the user supplies the electric motor 152 with electrical energy, which causes the saw blade 120 to rotate. Then the cutting arm 116 is moved from the upper position to the lower position, which causes the saw blade 120 to cut through the workpiece. After the workpiece is cut, the user returns the cutting arm 116 to the upper position and deenergizes the electric motor 152.

As the cutting arm 116 is moved to the lower position the blade guard 160 moves toward the open position, against the force of the biasing member 168, so that the saw blade 120 is exposed to the workpiece. In this position, the blade guard 160 and the blade guard space 148 contains, at least partially, the dust and debris generated by the saw blade 120 as it cuts the workpiece.

During the cutting operation, the dust and debris are generally withdrawn from the blade guard space 148 and from within the blade guard 160 by the draft created by the rotating saw blade 120 or by a dust collection system. Since the biasing member 168 is spaced apart from the blade guard space 148 and the blade guard 160, operation of the biasing member is generally unaffected by the dust and debris.

As the cutting arm 116 is returned to the upper position, after cutting the workpiece, the biasing member 168 biases the blade guard 160 toward the closed position. When the cutting arm 116 is in the upper position, the biasing member 168 biases the blade guard 160 in the closed position.

The location of the blade guard 160, the linkage arm 164, the biasing member 168, and the housing assembly 176 prevents these elements from limiting the maximum bevel angle of the cutting arm 116 and from limiting the vertical cutting capacity of the power saw 100. First, since the power saw 100 includes a biasing member 168 that is located outside of the blade guard space 148 and away from the blade guard 160, the cutting arm 116 is generally narrower as measured in the direction of the axis of rotation 190 than some other power saws, which include a helical torsion spring (or other type of biasing member) positioned about the hub 178 of the blade guard 160 near the axis of rotation 190. Typically, the torsion springs of these other power saws have a width that tends, at least to some degree, to limit the maximum bevel angle of the cutting arm. Second, as shown in FIG. 6, the linkage arm 164 and the biasing member 168 are spaced apart from the region between the axis of rotation 190 and the workpiece support surface 128 (FIG. 1). This location of the linkage arm 164 and the biasing member 168 prevents these elements from limiting the vertical cutting capacity of the power saw 100, as compared to the typical power saw that includes a torsion spring (or other biasing member) positioned between the axis of rotation and the workpiece support surface.

As shown in FIG. 7, when the cutting arm 116 is in the upper position, the blade guard 160 is movable (by a user) from the closed position to the open position, and to another open position referred to as a toggle open position. The toggle open position of the blade guard 160 is useful when removing and attaching the saw blade 120 to the cutting arm 116. To position blade guard 160 in the toggle open position, the cutting arm 116 is positioned in the upper position and the blade guard is rotated about the axis of rotation 190 in the direction 228. In this position, the first portion 180 of the linkage arm 164 is located between the axis of rotation 190 and the workpiece support surface 128 in a position that causes the linkage arm and the biasing member 168 to bias the blade guard 160 in the direction 228 (FIG. 7). Accordingly, in the toggle open position, the blade guard 160 is held in the open position without user involvement.

The toggle open position simplifies changing of the saw blade 120 and enables the user to use both hands to remove the saw blade 120 from the cutting arm 116; instead of using one hand to hold the blade guard 160 and the other to remove the saw blade. The power saw 100 cannot be used to cut a workpiece with the blade guard 160 in the toggle open position, since the power saw 100 includes an interlock assembly (not shown) that prevents movement of the cutting arm 116 and energization of the electric motor 152 when the blade guard is in the toggle open position. In some embodiments, when the blade guard 160 is in the toggle open position, movement of the cutting arm 116 toward the lower position causes the blade guard to exit the toggle open position and return to the closed position.

The biasing member 168, which is a compression spring, is arranged in a “push” orientation in that the biasing member pushes the blade guard 160 toward the closed position. In another “push” embodiment of the blade guard 160, the biasing member 168 is an extension spring positioned between the pin 196 and second slot end portion 195 of the linkage arm 164. In both “push” embodiments, the connection point of the first end portion 180 of the linkage arm 164 to the blade guard 160 is positioned above the axis of rotation 190 when the blade guard is in the closed position.

A “pull” embodiment (not shown) of the blade guard 160, has the first end portion 180 of the linkage arm 164 connected to the blade guard 160 in a position that is between the axis of rotation 190 and the workpiece support surface 128, when the blade guard is in the closed position. One particular “pull” embodiment of the blade guard 160 includes a biasing member 168 provided as an extension spring positioned between the pin 196 and the first slot end portion 193 of the linkage arm. Another “pull” embodiment of the blade guard 160 includes a biasing member provided as a compression spring positioned between the pin 196 and the second slot end portion 195.

In yet another embodiment, the biasing member 168 is an air cylinder(s), an elastomeric material(s), a magnet(s), and a leaf spring(s) arranged in the “push” embodiment, the “pull” embodiment, or another arrangement.

While the power saw 100 has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A power saw comprising:
a base portion;
a support assembly supported by said base portion;
a cutting arm supported by said support assembly, said cutting arm configured to rotatably support a saw blade, said cutting arm movable between a lower position adjacent to said base portion and an upper position spaced apart from said base portion;
a blade guard rotatably supported by said cutting arm and configured to receive a portion of said saw blade therein;
a linkage arm including a first end portion pivotally connected to said blade guard, and a second end portion movably supported by said support assembly; and
a biasing member operably connected to said second end portion and configured to bias said linkage arm such that as said cutting arm moves from said lower position to said upper position, said linkage arm is biased by said biasing member and said linkage arm biases said blade guard toward a closed position.

2. The power saw of claim 1, wherein said second end portion extends along an axis, said linkage arm further including:
a middle portion located between said first end portion and said second end portion, said middle portion angled with respect to said axis.

3. The power saw of claim 2, wherein said middle portion defines an angle with said axis of between 65 and 90 degrees.

4. The power saw of claim 2, wherein:
when said cutting arm is in said upper position, said blade guard is movable by a user from said closed position to an open position, and
said linkage arm is configured such that when said cutting arm is in said upper position and said blade guard is in said open position, said linkage arm is biased by said biasing member toward a position whereat said linkage arm biases said blade guard toward said open position.

5. The power saw of claim 1, wherein:
said second end portion defines a slot,
a pin supported by said support assembly extends into said slot, and
said biasing member is operably connected to said pin.

6. The power saw of claim 5, further comprising a seat, wherein:
said seat is at least partially positioned within said slot,
said seat is movable along said slot,
said seat is operably connected to said biasing member, and
said seat is operably connected to said pin.

7. The power saw of claim 6, further comprising:
a housing assembly including a left housing assembly member and a right housing assembly member, said left housing assembly member defining a left slot passage through said left housing assembly member, and said right housing assembly member defining a right slot passage through said right housing assembly member.

8. The power saw of claim 7, wherein said seat includes a guide that is slidably positioned in at least one of said left slot passage and said right slot passage.

9. The power saw of claim 1, wherein said biasing member is a compression spring.

10. The power saw of claim 1, wherein said biasing member is an extension spring.

11. The power saw of claim 1, further comprising:
a turntable rotatably supported by said base portion,
wherein said support assembly extends from said turntable.

12. The power saw of claim 11, wherein said power saw is a miter saw.

13. The power saw of claim 12, wherein:
said support assembly includes a slide structure, and
said cutting arm is pivotally coupled to said slide structure.

14. The power saw of claim 1, wherein:
said cutting arm defines a blade guard space,
wherein at least a portion of said blade guard is positioned in said blade guard space, and
wherein at least a portion of said linkage arm is positioned in said blade guard space.
